(19) United States
(12) Patent Application Publication
(10) Pub. No.: US 2008/0020110 A1
(43) Pub. Date: Jan. 24, 2008

(54) Systems for producing sterilized aseptic food products by ohmic heating with post-addition of salted water

(75) Inventor: Guillaume Dock, Caumont sur Durance (FR)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Campbell France S.A.S., a corporation of France, Le Pontet (FR)

(21) Appl. No.: 11/879,166

(22) Filed: Jul. 16, 2007

(30) Foreign Application Priority Data
Jul. 24, 2006 (FR) 06/06758

(51) Int. Cl. B65B 55/14; A23L 3/00; B01J 19/08

(52) U.S. Cl. 426/392; 99/483

(57) ABSTRACT

A method of sterilizing a food composition formed from a heterogeneous mixture of at least one liquid phase and solid particles including a step of preparing a concentrated liquid/particles phase with a reduced amount of salt, a sterilization step including a phase of ohmic heating and a phase of holding the concentrated phase, a step of cooling the sterile concentrated phase, and a packaging step, wherein the concentrated phase is mixed after the heating phase with an aqueous phase including sterile salted water for formulation of the heterogeneous mixture of at least one liquid phase and solid particles.

### Related Application

This application claims priority of French Patent Application No. 06/06758, filed Jul. 24, 2006, herein incorporated by reference.

### TECHNICAL FIELD

This disclosure relates to preparation of food compositions, in particular, soups and installations for implementing such methods.

### BACKGROUND

The sterilization of heterogeneous food products comprising a liquid phase and particles such as soups poses the problem of heterogeneity of the heating related to the presence of two phases, a liquid and a solid.

The method of heating food products comprising a liquid phase and particles, described in EP B1 0 323 654, is known.

EP '654 concerns a method for heat treatment of a continuous flow of a mixture of substances consisting of a liquid containing solid particles in which the mixture is heated to a certain desired temperature in one or more heat exchangers. The mixture of substances is maintained for a certain time at that temperature in a heat-maintaining device and then cooled to the desired final temperature in one or more heat exchangers. EP '654 proposes, for the heat treatment of a mixture of substances containing solid particles of different sizes able to be split into a number of dimensional fractions, to regulate separately, according to the size of the solid particles in a considered fraction, the transit time of the different dimensional fractions of solid particles in the heat-maintaining device. This regulation is proposed independently of the transit time of the liquid in the heat-maintaining device, the solid particles being continuously skirted round by the circulating liquid.

That proposal applies longer heat treatment times for the larger-sized constituents of the mixture. That leads to heating to a temperature adapted to guarantee sterility. Then, maintaining the temperature is adjusted according to the size of the particles.

A drawback of that approach is that, to guarantee the sterilization of all the constituents, including the largest sized ones, it is necessary to set the initial heating temperature of the mixture at a high value, adapted to the large-sized constituents, but excessive for the smaller-sized constituents. This leads to a degradation of the organoleptic quality of the food product thus prepared.

### SUMMARY

I provide a method of sterilizing a food composition formed from a heterogeneous mixture of at least one liquid phase and solid particles including a step of preparing a concentrated liquid/particles phase with a reduced amount of salt, a sterilization step including a phase of ohmic heating and a phase of holding the concentrated phase, a step of cooling the sterile concentrated phase and a packaging step.

I also provide an installation for sterilizing a food composition formed from a heterogeneous mixture of at least one liquid phase and solid particles, including a mixer supplied with a salted sterile aqueous phase and a concentrated liquid/particles phase with a reduced amount of salt, and a sterilizer of the concentrated phase including at least one ohmic heating tube and at least one hold tube and a cooling system.

### BRIEF DESCRIPTION OF THE DRAWINGS

My systems and methods will be better understood from a reading of the following description, referring to the accompanying drawings relating to non-limiting, representative examples where:

FIG. 1 depicts a schematic view of the installation allowing sterilization and packaging of food products comprising one ohmic heating section; and

FIG. 2 depicts a schematic view of the installation allowing sterilization and packaging of food products comprising two ohmic heating sections in series.

### DETAILED DESCRIPTION

It will be appreciated that the following description is intended to refer to specific examples of structure selected for illustration in the drawings and is not intended to define or limit the disclosure, other than in the appended claims.

I provide methods of sterilizing a food composition formed from a heterogeneous mixture of at least one liquid phase and solid particles, comprising:
preparing a concentrated liquid/particles phase with a reduced amount of salt,
a sterilization step including a phase of ohmic heating and a phase of holding the concentrated phase,
a step of cooling the sterile concentrated phase, and
a packaging step,
   wherein the concentrated phase is mixed after the heating phase with an aqueous phase comprising sterile salted water for final formulation of the heterogeneous mixture of at least one liquid phase and solid particles.

Ohmic heating allows a rapid temperature rise preserving the organoleptic qualities of the foods and is used for sterilizing foods.

It allows heating of foods by the flow of an electric current, the resistance of the product to the circulation of electricity causing the temperature to increase. Ohmic heating devices comprise a tubular central duct at the ends of which electrodes are placed, with holes to allow the introduction of a fluid into the tube and its collection. These two electrodes are perpendicular to both the duct and the general direction of flow of the fluid.

I implement the ohmic heating according to particular forms adapted to the separate heating of the concentrated phase. As the conductivity of a compound is dependent on its salinity and temperature, the purpose of adjusting the salinity of the concentrated phase is to optimize the conditions for implementing its heating. This is because heating heterogeneity is due partly to the difference in electrical conductivity of the ingredients in complex food products.

As a general rule, stews and ready-made meals have salt contents ranging from 0.7% to 1.2%. This salt, during preparation of the products, is added to the liquid phase and dissolves. However, ionic diffusion from the liquid to the heart of the solid products is relatively slow and difficult to control industrially. This results in great heterogeneity of the electrical conductivity of the particles. This constraint partly explains that the majority of ohmic heating applications concern only homogeneous products.

Mixing the sterile concentrated phase with the aqueous phase comprising sterile salted water may be carried out between the sterilization step and the cooling step to optimize cooling the sterile concentrated phase.

Advantageously, the aqueous phase comprising sterile salted water is cooled to a temperature below about 10° C., before mixing with the sterile concentrated phase.

Mixing the sterile concentrated phase with the aqueous phase comprising sterile salted water may be carried out during packaging in the final container of the product by double aseptic proportioning to improve the accuracy of the proportioning of each phase.

Mixing the concentrated phase heated to the sterilization temperature with the aqueous phase comprising sterile salted water heated to the sterilization temperature may be carried out before holding to limit the risks of loss of sterility due to implementation of the mixing.

The salt concentration of the liquid part of the concentrated phase may be less than about 0.5%.

The conductivity of the components of the concentrated phase is substantially homogeneous and the difference in conductivity of the components does not exceed 1 to 3.

The conductivity of the concentrated phase is less than about 10 milliSiemens/centimeter at 25° C.

The salt concentration of the aqueous phase may depend on the salt concentration of the concentrated phase so that the solution resulting from mixing of the two phases is at about 0.7% salt on average.

Preferably, the concentrated phase comprises a thickener.

The ohmic heating temperature of the concentrated phase may be between about 130° C. and about 140° C.

Sterilization of the concentrated phase may be carried out by passage through a first ohmic heating tube providing a temperature rise, then by passage through an intermediate holding tube providing homogenization of the temperature, and then through a second ohmic heating tube providing a second increase in temperature.

I also provide an installation for sterilizing a food composition formed from a heterogeneous mixture of at least one liquid phase and solid particles, for implementation of the method, comprising a mixer supplied on the one hand with a salted sterile aqueous phase, and on the other hand with a concentrated liquid/particles phase with a reduced amount of salt. The installation also comprises equipment for sterilizing the concentrated phase comprising at least one ohmic heating tube and at least one holding tube and a cooling system.

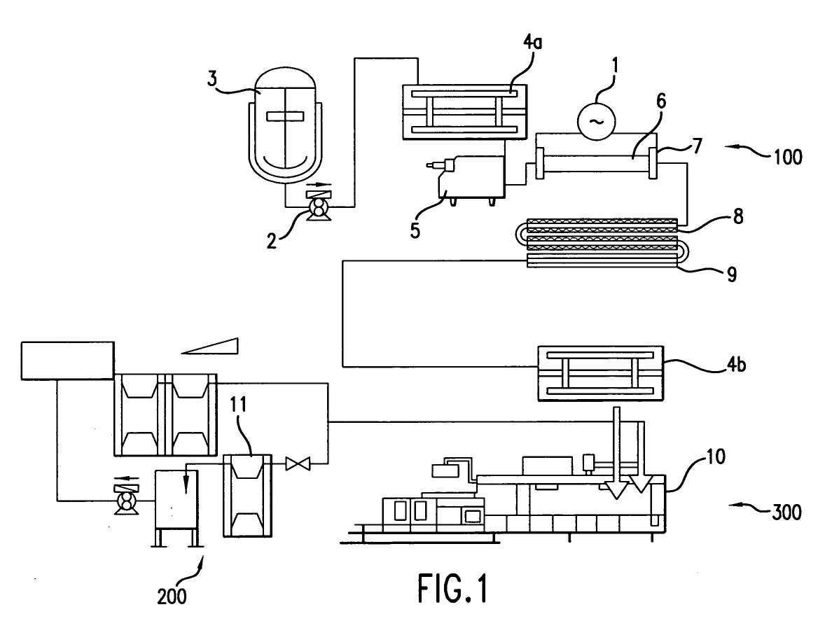

Turning now to the Drawings, FIG. 1 depicts a schematic view of a first example of an installation/system.

It comprises two parallel production lines, the first line (100) being intended for preparation and sterilization of the concentrated phase, and the second line (200) being intended for preparation and sterilization of the aqueous phase. A last station (300) carries out the mixing of these two phases thus sterilized and prepared, and their packaging.

The first sterilization line (100) comprises a feed hopper (3) formed by a vessel incorporating a mixer. This hopper (3) is supplied with pieces of vegetable, pieces of meat, water, one or more thickeners, flavorings and seasonings, and the like.

The salinity of this mixture is checked and adjusted as will be described later. In particular, the salt content is less than the final content aimed for, and adapted mainly according to the ohmic heating conditions sought. Similarly, the water content is adjusted to make it possible to guarantee good homogeneity and, therefore, it is sought to concentrate the mixture that the solid pieces (meat, vegetables) are conveyed by a viscous carrier phase providing good thermal conduction and good carrying capacity in the ohmic heating column.

A positive transfer piston or lobe pump (2) provides the supply for a buffer tank (4a). The primary characteristic of the positive transfer pump (2) is to allow the transfer of products with large pieces while preserving the integrity of the pieces. The content of the buffer tank (4a) is used for the supply in a continuous flow of a second pump (5) which supplies the ohmic heating column (6).

The whole of this upstream supply chain is configured to preserve the solid pieces contained in the mixture.

The ohmic heating column (6) comprises a tube made from insulating materials and comprises electrodes (7) powered by a voltage source (1). The voltage and transit time of the concentrated phase are adjusted to substantially guarantee sterilization of the constituents of the concentrated phase without overheating. The heating parameters are set by an experimental method comprising incrementally increasing the time and/or the voltage applied to the electrodes until the bacteriological quality at the output of the installation reaches a satisfactory level. Maintaining these parameters can be controlled by a regulating device connected to a temperature probe measuring the temperature at the output of the column (6).

The ohmic heating tube (6) can have a particular configuration to allow heating of a continuous flow of product and to make the transit time of the compounds of the food product uniform. It then comprises a heating pipe of tubular cross-section made from electrically insulating material having at its two ends an annular electrode. The two electrodes are connected to an electrical power source. The heating installation is supplied by a feed pump driven by a first motor. The tube comprises a worm comprising a non-conductive material, driven by a second motor controlled to provide a flow rate in the heating chamber synchronous with the supply flow rate. The worm delimits spaces partitioned by two consecutive segments, providing regular driving of the products introduced into the heating column, despite their heterogeneity.

The concentrated phase at the output of the ohmic heating column (6) supplies a holding tube (8) formed from tubes for maintaining the temperature to homogenize the temperature of the concentrated phase, and finalize the sterilization treatment. At the output of the holding tube (8), the concentrated phase thus sterilized is cooled in a tubular heat exchanger (9). The walls of the tubular heat exchanger (9) are cooled by circulation of cold water. Then, the sterile concentrated phase is stored in a buffer tank (4b).

The second sterilization line (200) comprises a supply of salted water whereof the salinity is adjusted that the end product, after mixing of the two phases, has a satisfactory salt content. The content of this liquid phase is determined to compensate for the salt deficit of the concentrated phase, after final mixing.

Line (200) has a means of sterilization by heating in plate heat exchangers (11). A control valve adjusts the flow rate of the sterilized liquid phase according to the final salt and water contents sought. Excess aqueous phase is reintroduced into the second sterilization line by a return circuit.

The two sterilized phases are then mixed in a packaging station (10).

This installation constitutes a simple non-limiting example and the following description concerns more specifically the steps of a method implemented by this installation.

In the concentrated phase, two phases are distinguished, a so-called “carrier phase,” which is liquid, and a “solid phase.” The concentrated phase comprises the ingredients necessary for producing the end product. It is, however, provided with a reduced amount of water and salt to obtain a concentrated phase having a relative homogeneity of conductivity of the components providing homogeneous heating between the particles and the carrier phase. The difference in conductivity between the different components does not exceed the factors 1 to 3.

The solid ingredients have an electrical conductivity that can be quite small—on the order of about 2 to about 6 mS/cm at 25° C.

The average conductivity of this carrier phase cannot exceed about 10 mS/cm at 25° C. This results in a salt content of the concentrated phase which must be less than about 0.5%.

The aqueous phase intended to be mixed with the concentrated phase after its heating is a saline solution. Salt means the food-quality salt which consists mainly of sodium chloride, although natural contaminants can also be present in variable amounts, depending on the origin and method of production of the salt. The salt concentration of this phase depends on the ratio of the concentrated phase and the salt content present in the concentrated phase. For example, for a phase concentrated at about 60% and salted at about 0.5%, the amount of salted water will be about 40% with a salt content of about 1.3% to achieve an average salinity of the reconstituted product of about 0.7%.

Sterilization of the aqueous phase depends on its salt concentration. This is because, if the salt concentration is higher than about 1.5%, sterilization is carried out by filtration over a double filter comprising pores of about 0.2 μm diameter. On the other hand, for concentrations below about 1.5% salt, the product can undergo a conventional heat sterilization at 140° C., in a tubular heat exchanger or a plate heat exchanger as shown schematically in FIG. 1.

The concentrated phase, after heating or sterilization, has a sterile aqueous phase added to obtain the final composition of the food product.

In fact, once the concentrated phase is heated by the ohmic heating column 6, its mixing with the aqueous phase can take place equally well at all the following steps.

The mixing may take place as shown schematically in FIG. 1, during packaging, by double aseptic proportioning in the final container of the product. This technique allows an accurate proportioning of the concentrated phase and then of the aqueous phase into the presterilized container. Prior sterilization of the container can be performed by the use of peroxide or any other sterilization method. Mixing is done in sterile surroundings, that is to say, under a laminar flow, for example, or in a chamber with overpressure of sterile air. The container, once hermetically sealed, can be subjected to agitation to mix the two phases.

The mixing may also be done further upstream and, in particular, at the output of the holding tube 8. In this case, the saline solution is cooled to a temperature below about 10° C. before its incorporation into the concentrated phase. This technique makes it possible to optimize cooling the concentrated phase since the final mixed product must have a temperature below about 40° C.

Mixing may further be carried out directly after the ohmic heating, by mixing of the two solutions heated to the sterilization temperature before the holding tube 8. This possibility makes it possible to perform mixing outside the aseptic area and, consequently, to limit the risks of loss of sterility due to implementation of the mixing. A combination of the preceding mixing possibilities can be envisaged.

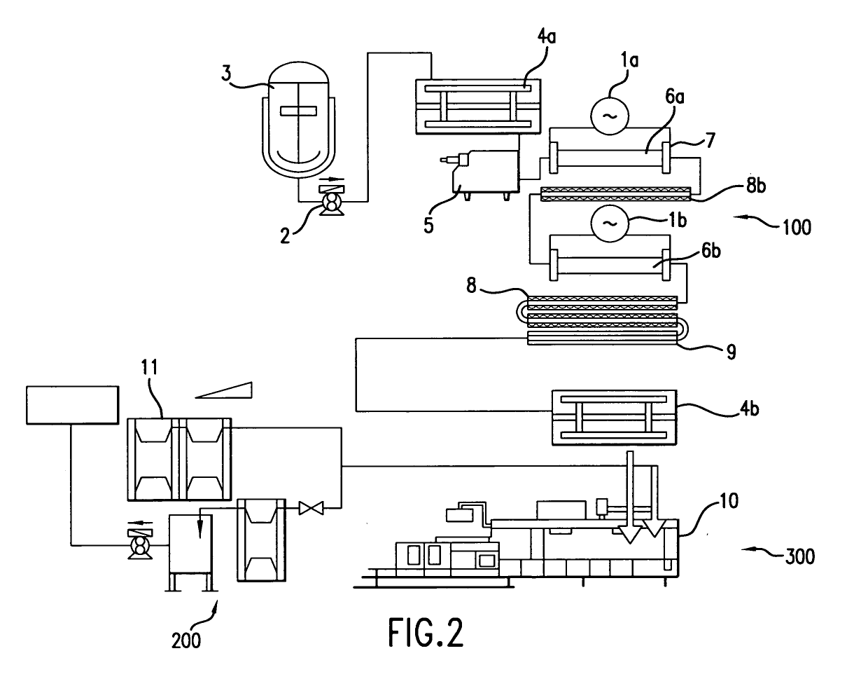

The ohmic heating of the concentrated phase can be improved by the use of two ohmic heating sections 6a and 6b (FIG. 2) in series. The two sections 6a and 6b are separated by an intermediate holding tube 8b. The intermediate holding tube 8b makes it possible to provide a homogeneous temperature between the particles and the liquid of the concentrated phase before a new temperature rise in the second ohmic heating section 6b. As the conductivity is a function of the temperature of the compound, this homogenization of the temperatures makes it possible to optimize the second ohmic heating cycle.

This additional holding takes place at temperatures that are still relatively low and, therefore, does not have a significant repercussion on the organoleptic degradation of the product.

After the second ohmic heating section 6b, the treatment undergone by the concentrated phase is the same as previously described. Namely, transit of the concentrated phase through the final holding tube 8 allowing the degradation of germs; cooling by the tubular heat exchanger 9 and packaging of the concentrated phase and the aqueous phase by the packaging system 10.

The use of an intermediate holding tube 8b allows a reduction of the ratio of volume/final holding time and therefore better preservation of the organoleptic qualities of the products.

1. A method of sterilizing a food composition formed from a heterogeneous mixture of at least one liquid phase and solid particles comprising:
a step of preparing a concentrated liquid/particles phase with a reduced amount of salt,
a sterilization step comprising a phase of ohmic heating and a phase of holding the concentrated phase,
a step of cooling the sterile concentrated phase, and
a packaging step,
wherein the concentrated phase is mixed after the heating phase with an aqueous phase comprising sterile salted water for formulation of the heterogeneous mixture of at least one liquid phase and solid particles.

2. The method according to claim 1, wherein mixing the sterile concentrated phase with the aqueous phase comprising sterile salted water is carried out between the sterilization step and the cooling step to optimize cooling the sterile concentrated phase.

3. The method according to claim 2, wherein the aqueous phase comprising sterile salted water is cooled to a temperature below about 10° C. before mixing with the sterile concentrated phase.

4. The method according to claim 1, wherein mixing the sterile concentrated phase with the aqueous phase comprising sterile salted water is carried out during packaging in a final container of the product by double aseptic proportioning to improve accuracy of proportioning of each phase.

5. The method according to claim 1, wherein mixing the concentrated phase heated to a sterilization temperature with the aqueous phase comprising sterile salted water heated to the sterilization temperature is carried out before the holding to limit risks of loss of sterility due to implementation of the mixing.

6. The method according to claim 1, wherein the salt concentration of the liquid part of the concentrated phase is less than about 0.5%.

7. The method according to claim 1, wherein conductivity of components of the concentrated phase is substantially homogeneous and the ratio of components conductivities does not exceed 1 to 2.

8. The method according to claim 1, wherein conductivity of the concentrated phase is less than about 10 milliSiemens/centimeter at 25° C.

9. The method according to claim 1, wherein the salt concentration of the aqueous phase depends on the salt concentration of the concentrated phase so that a solution resulting from mixing the phases is at about 0.7% salt on average.

10. The method according to claim 1, wherein the concentrated phase comprises a thickener.

11. The method according to claim 1, wherein the ohmic heating temperature of the concentrated phase is between about 130° C. and about 140° C.

12. The method according to claim 1, wherein sterilization of the concentrated phase is carried out by passage through a first ohmic heating tube providing a temperature rise, then by passage through an intermediate holding tube providing homogenization of the temperature, and then through a second ohmic heating tube providing a second increase in temperature.

13. An installation for sterilizing a food composition formed from a heterogeneous mixture of at least one liquid phase and solid particles, comprising:
a mixer supplied with a salted sterile aqueous phase and a concentrated liquid/particles phase with a reduced amount of salt, and
a sterilizer of the concentrated phase comprising at least one ohmic heating tube and at least one holding tube and a cooling system.
